(19) United States
(12) Patent Application Publication
(10) Pub. No.: US 2011/0001437 A1
(43) Pub. Date: Jan. 6, 2011

(54) Hoist Cable Illuminator

(75) Inventors: John D. Marcaccio, Mt. Airy, NC (US); Terry F. Martin, Meadows of Dan, VA (US); Ricky L. Boyd, Meadows of Dan, VA (US); Joseph J. Flythe, JR., Camden, NC (US); Philip J. Ernst, Cana, VA (US); Kenneth R. Wagner, Danbury, CT (US)

Correspondence Address: BANNER & WITCOFF, LTD., 1100 13th STREET, N.W., SUITE 1200, WASHINGTON, DC, 20005-4051, US

(73) Assignee: Aerial Machine & Tool Corp., Vesta, VA (US)

(21) Appl. No.: 12/497,037

(22) Filed: Jul. 2, 2009

(51) Int. Cl. H05B 37/02; G01J 3/10

(52) U.S. Cl. 315/294; 250/504 R

(57) ABSTRACT

Individual illuminating modules can be coupled to each other and attached to a bumper on the end of a hoist cable. Different types of illumination modules can have similar outer dimensions and attachment fittings, but can be configured to provide different types of illumination. Modules of different types can be combined to accommodate particular circumstances or needs.

### BACKGROUND

In various types of helicopter operations, a cable hoist in a hovering aircraft is used to raise and/or lower persons or objects. In maritime rescue operations, for example, a rescue swimmer may jump into the water from a helicopter to aid persons in distress or may be lowered from the helicopter by a cable hoist. That cable hoist is then used to raise the rescued person and the rescue swimmer to the aircraft. In particular, the rescue swimmer can attach a hooked end of the cable to a lifting cage holding the rescued person or to a harness fitted around the rescued person. Similarly, the rescue swimmer can attach that hook to a harness that he or she is wearing and be hoisted back into the helicopter.

During these and other helicopter operations, it is important for the cable end to be readily locatable. In the helicopter, for example, a crew chief operating the hoist may be watching the position of the hooked cable end and relaying instructions so that the pilot can position the aircraft to place the hooked cable end in a desired location. In the water, a rescue swimmer must be able to quickly find the cable end so that the hook can be attached to the rescued person or to the rescue swimmer. Similar concerns arise in other types of military operations. For example, a helicopter may be used to extract special operations personnel from the ground or from the water during combat conditions. When extracting personnel by helicopter from a combat zone, it is generally desirable to minimize the amount of time the helicopter must spend hovering over an extraction site. If the extracted personnel have trouble finding a lowered cable, the time for their extraction may be unnecessarily (and dangerously) extended.

Many maritime rescues, combat extractions, and similar helicopter operations are performed at night and/or in adverse weather. In such conditions, visibility may be quite poor. Visualizing the end of a lowered cable can thus be quite difficult.

### SUMMARY

This Summary is provided to introduce a selection of concepts in a simplified form that are further described below in the Detailed Description. This Summary is not intended to identify key features or essential features of the invention.

In at least some embodiments, individual illuminating modules can be coupled to each other and attached to a bumper on the end of a hoist cable. Each module can include its own power source, control circuitry, and lighting elements. Different types of illumination modules can have similar (or identical) outer dimensions and attachment fittings, but can be configured to provide different types of illumination. For example, one module may provide illumination in one color and another module may provide illumination in a different color. Still other modules may provide infra-red illumination. Some modules may be configured to illuminate in a flashing pattern, while others may provide continuous illumination. Modules of different types can be combined to accommodate particular circumstances or needs.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows a helicopter lowering a hooked cable end having a hoist cable bumper illuminator according to some embodiments.

FIG. 2 is an enlarged view of the hooked cable end from FIG. 1.

FIG. 3 is a perspective view of an illuminator according to some embodiments attached to a hoist cable bumper.

FIG. 4 is an exploded perspective view of the illuminator and bumper from FIG. 3.

FIG. 5 is a view of the inside of an illuminator module from FIG. 4.

FIG. 6 illustrates several possible combinations from a set of illuminator modules having similar outer dimensions and attachment fittings but configured to provide different types of illumination.

FIG. 7 is an exploded perspective view of an illuminator and bumper according to another embodiment.

FIG. 8 is a side view of the illuminator and bumper of FIG. 7.

FIG. 9 is a top view of the illuminator and bumper of FIG. 7.

### DETAILED DESCRIPTION

Embodiments of the invention are described by reference to various types of helicopter operations. However, the invention is also applicable to other activities and can be used by other types of vehicles and/or with other types of equipment. As used herein (including the claims), “coupled” includes two components that are attached (either fixedly or movably) by one or more intermediate components.

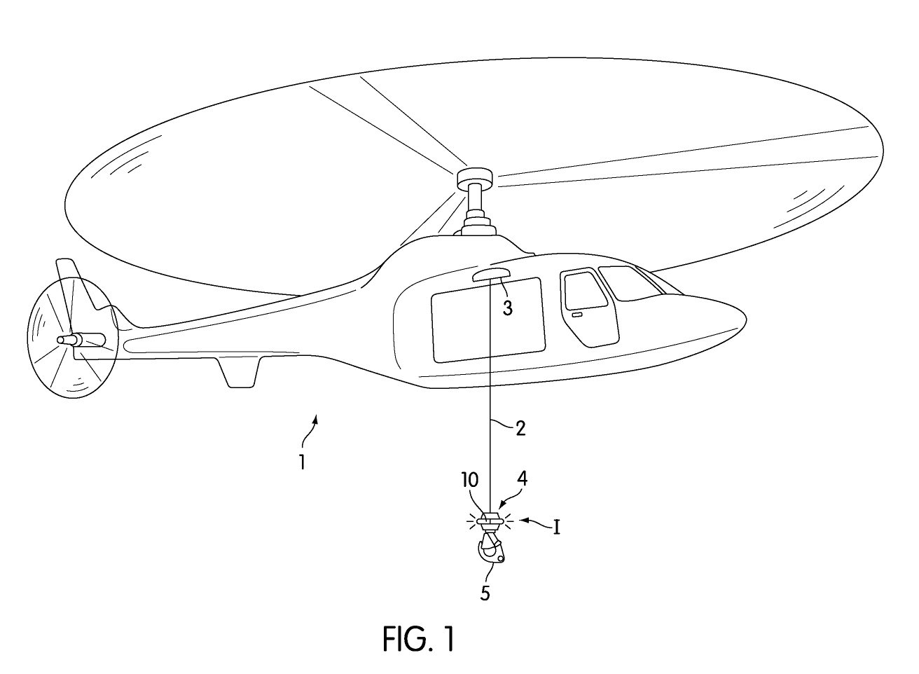

FIG. 1 shows a helicopter 1 lowering a cable 2 from a hoist 3. Attached to the end 4 of cable 2 are a hook 5 and an illuminator 10 according to some embodiments. Illumination (I) emanates from illuminator 10. As discussed in more detail below, illumination I may be light in any of various colors of visible light. As used herein, “visible light” refers to light that is perceptible to the unaided human eye, and which generally includes electromagnetic radiation having wavelengths between 380 nanometers (nm) and 750 nm. In some embodiments, illumination I is in the infra-red portion of the electromagnetic spectrum and substantially no visible light is emitted. As used herein, “infra-red” refers to illumination at wavelengths over 750 nm that is not perceptible to the unaided human eye, and “substantially no visible light” means that any amount of visible light emitted is not perceptible to the unaided human eye. As also used herein, “color” includes visible light and infra-red illumination. Illumination I can be constant, can be flashing, or can include a combination of constant and flashing illumination.

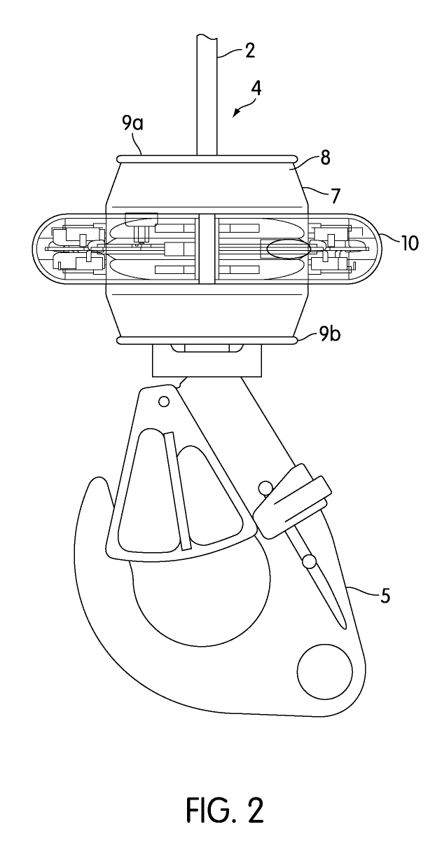

FIG. 2 is an enlarged view of cable end 4 from FIG. 1. Hook 5 is attached to the end of cable 2, in a manner known in the art, within a hollow core of bumper 7. Hook 5 could be, e.g., a rescue such as is described in commonly-owned U.S. Pat. No. 6,363,589. Bumper 7, which is also attached to cable end 4 above hook 5, has a hard rubber body 8 with metal strike plates 9a and 9b on the bumper ends. When bumper 7 reaches hoist 3 as cable 2 is taken up, strike plate 9a contacts a cutoff switch (not shown in FIG. 1) to stop hoist 3. Illuminator 10 is attached to an outside surface of bumper main body 8 in a manner described below.

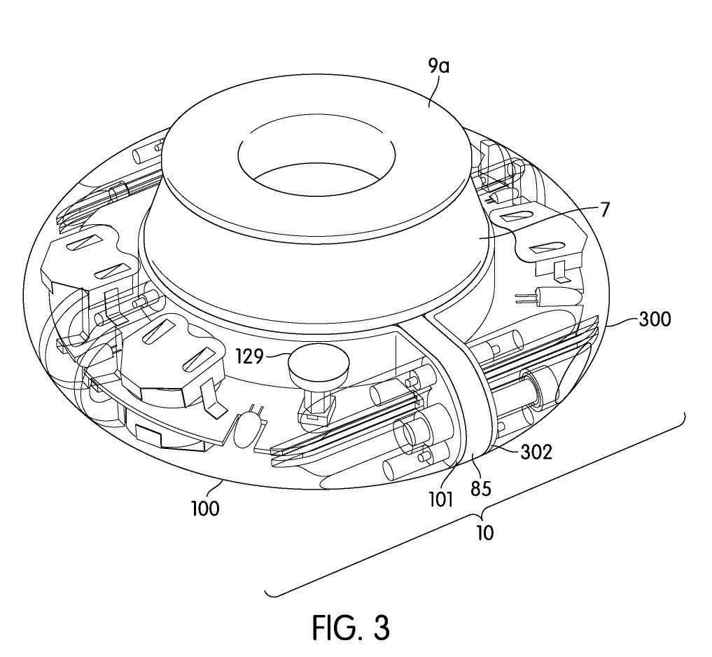

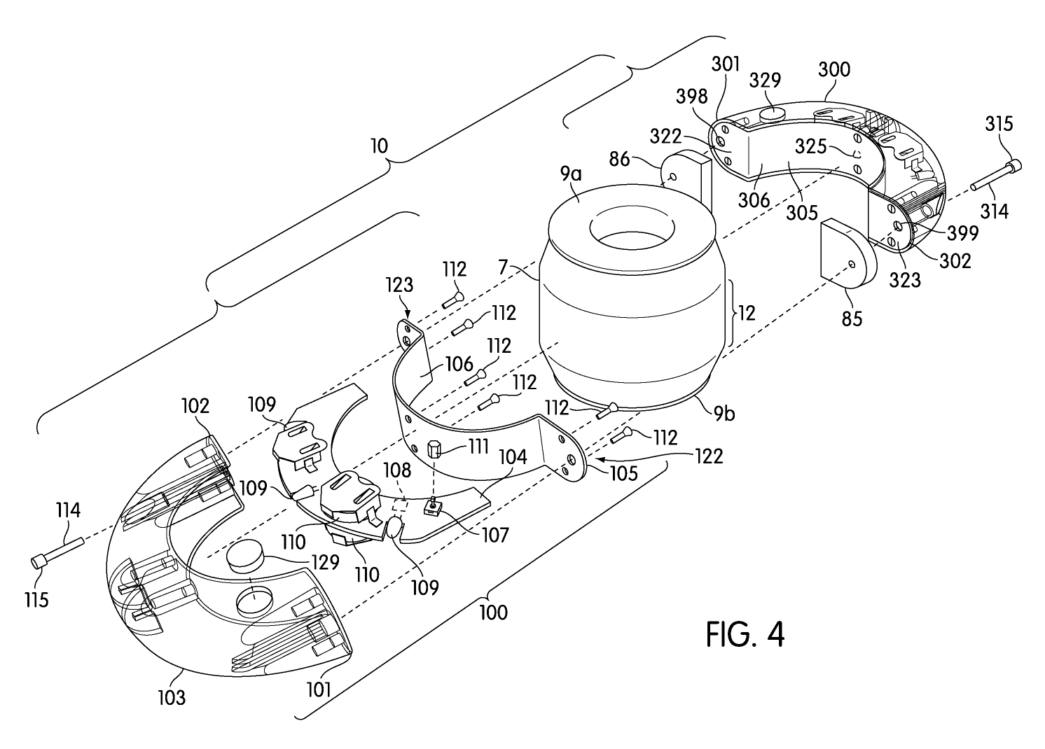

FIG. 3 is a perspective view of illuminator 10 and bumper 7, but with cable 2 and hook 5 removed for convenience. Illuminator 10 includes a first module 100 having ends 101 and 102 (not visible in FIG. 3, but visible in FIG. 4) and a second module 300 having ends 301 (see FIG. 4) and 302. End 101 of module 100 is coupled to end 302 of module 300 by a screw (not shown in FIG. 3, but discussed below in connection with FIG. 4). Similarly, end 102 of module 100 is coupled to end 301 of module 300 by a second screw (also not shown in FIG. 3). A first compressible element 85 is positioned between ends 101 and 302 and a second compressible element 86 is positioned between ends 102 and 301 (see FIG. 4). A waterproof diaphragm 129 on module 100 can be pressed to actuate a switch 107 (see FIG. 4) to activate module 100 and then pressed again to deactivate module 100. A similar diaphragm 329 (FIG. 4) located on module 300 is pressable to activate and deactivate module 300.

FIG. 4 is an exploded view of illuminator 10 and bumper 7 from FIG. 3 showing modules 100 and 300 separated from bumper 7. Individual components of module 100 are similarly separated. Module 300 in the embodiment of FIGS. 1-5 is identical to module 100 and thus is not exploded to show its internal components.

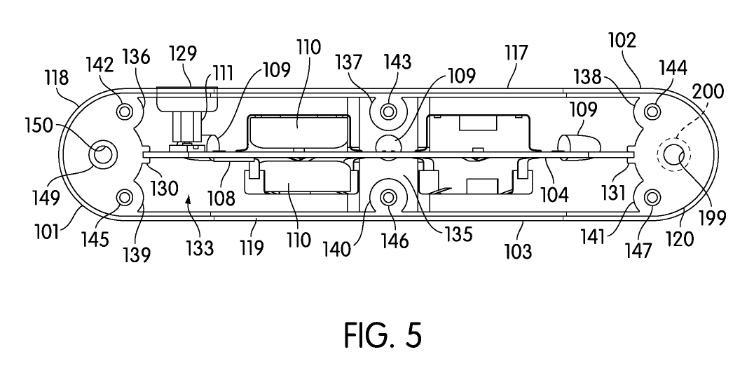

Module 100 includes a housing that comprises an outer shell 103 and an inner backing 105. Outer shell 103 is transparent and formed from polycarbonate resin thermoplastic (“polycarbonate”), such as that sold under the trademark LEXAN, or other impact resistant plastic. In some embodiments shell 103 is clear. In other embodiments shell 103 is colored. For example, shell 103 in some embodiments is formed from clear red polycarbonate. In other embodiments, shell 103 is formed from clear green polycarbonate, while in other embodiments shell 103 is formed from clear yellow polycarbonate. Other colors and combinations of colors could be used. Backing 105, which may (but need not be) opaque, is formed from polycarbonate or another appropriate plastic. Internal components of module 100 are attached to a circuit board 104 that fits within outer shell 103 in a manner described below in connection with FIG. 5. Once circuit board 104 is inserted into shell 103, backing 105 is secured in place with screws 112 to cover the opening of shell 103. So as to protect circuit board 104, the edges of backing 105 form a water-tight or water-resistant seal with corresponding edges 117, 118, 119 and 120 on shell 103 (see FIG. 5).

Components on circuit board 104 include a plurality of lighting elements 109, electrical control circuitry 108 (located on underside of circuit board 104) configured to control operation of lighting elements 109 in response to user input, one or more batteries 110 for powering lighting elements 109 and circuitry 108, and a control switch 107 for receiving user input. A push block 111 transfers force from a user finger pressing diaphragm 129 to switch 107. In some embodiments, circuit board 104 is modified to use batteries of readily-available sizes (e.g., AAA or AA). In at least some embodiments, lighting elements 109 are high intensity light-emitting diodes (LEDs) that emit white visible light when energized. In other embodiments, LEDs emitting red, green or other color light may be used. As can be appreciated, a module can thus be configured for emission of a particular color of visible light by employing a colored lighting element and a clear shell, by employing a white lighting element and a colored shell, or by combining colored lighting elements with a colored shell. In some embodiments, a single module may have LEDs or other lighting elements of multiple colors (e.g., a red LED, a white LED, a green LED), and/or may have a shell with different colors in different regions, so as to provide a multi-color module. Still other embodiments employ LEDs or other lighting elements that emit infra-red light (and that emit substantially no visible light) when energized. In still other embodiments, lighting elements other than LEDs may be used (e.g., incandescent bulbs). Operation of lighting elements 109 is described below.

Each of modules 100 and 300 includes a through-hole in one end and a threaded fastener hole in the opposite end. For example, end 302 of module 300 has a through-hole 399. Hole 399 is large enough to permit the threaded end of cap screw 314 to pass through and is countersunk on the opposite side of module 300. This countersink, which is not visible in FIG. 4, provides a shoulder against which the flange formed by the underside of the head 315 of cap screw 314 abuts when modules 100 and 300 are assembled. End 301 of module 300 has a threaded hole into which the threaded end of cap screw 114 is received. End 101 of module 100 similarly has a threaded hole (not visible in FIG. 4) into which the threaded end of cap screw 314 is received and a countersunk through-hole (also not visible) through which the threaded end of cap screw 114 passes. The countersink of the hole in end 102 provides a shoulder against which the flange of head 115 abuts.

The curved exposed faces 106 and 306 of backings 105 and 305, respectively, form substantially semicircular concave surfaces sized to conform to opposite sides of the cylindrical portion 12 of bumper 7. As used herein, “substantially semicircular” means the portion of a circular arc corresponding to radii having an angular separation of between approximately 175 degrees and approximately 180 degrees. Faces 106 and 306 are sized to fit cylindrical portion 12 of bumper 7. Although bumper sizes can vary based on manufacturer and application, an example diameter size for the cylindrical portion 12 of bumper 7 is approximately 3.5 inches. In other embodiments, curved exposed faces of backing plates form concave surfaces having a total arc that corresponds to circular radii separated by less than 170 degrees.

Illuminator 10 is assembled by placing modules 100 and 300 on opposite sides of bumper 7 so that faces 106 and 306 of backings 105 and 305 contact cylindrical region 12 of bumper 7. As modules 100 and 300 are brought together, a first compression pad 85 is inserted between flat exposed face portions 122 and 323 and a second compression pad 86 is inserted between flat exposed face portions 123 and 322. Pads 85 and 86 are formed from rubber or other compressible materials. Once modules 100 and 300 with interposed pads 85 and 86 are held in place around bumper 7, the threaded end of screw 314 is inserted through hole 399 in end 302 of module 300 and screwed into the threaded hole in end 101 of module 100. The threaded end of screw 114 is similarly inserted through the hole in end 102 of module 100 and screwed into the threaded hole 398 in end 301 of module 300. As screws 114 and 314 are tightened, modules 100 and 300 are pulled together and faces 106 and 306 of backings 105 and 305 compress cylindrical section 12 of bumper 7. Compression pads 85 and 86 permit modules 100 and 300 to be tightened so as to grip cylindrical section 12 even if section 12 is slightly out of round and/or has a diameter that varies from an expected diameter. A protrusion 325 on face 306 and a similar protrusion on face 106 extend radially inward. As screws 114 and 314 are tightened, protrusion 325 and the protrusion on face 106 are pushed into the rubber of bumper 7 and help to further secure illuminator 10 in place.

FIG. 5 is a side view of the inside of module 100, with backing 105 removed and looking radially outward through the inside of shell 103. Shell 103 can be fabricated by molding. Retaining channels 130 and 131 formed in the sides of the cavity 133 hold the edges of circuit board 104. A slotted bracket 135 formed in the central portion of cavity 133 holds the center of circuit board 104. Bosses 136-141 are formed in shell 103 and threaded metal inserts 142-147 installed therein so as to form receiving holes for screws 112 (see FIG. 4). A metal insert 149 installed in end 101 forms threaded hole 150 for receiving screw 315 (see FIG. 4). Through-hole 199 and countersink 200 are formed in end 102. Module 100 is assembled by aligning edges of circuit board 104 with channels 130 and 131 and the center of circuit board 104 with the slot of bracket 135, sliding circuit board 104 into place, and then installing backing 105 with screws 112 (see FIG. 4). This construction allows simple assembly, disassembly (e.g., for battery replacement) and reassembly of module 100. Edges 117, 118, 119 and 120 of shell 103 contact edges of backing 105 when module is assembled.

In the embodiment of FIGS. 1-5, control circuitry 108 is configured to have two operating modes. In an OFF mode, lighting elements 109 are not energized and no illumination is generated. In an ON mode, lighting elements 109 are energized so as to generate constant illumination. As used herein, “constant” illumination means that illumination is not interrupted until a user deactivates a module or otherwise provides an input (or until a power source is depleted or the module is damaged). Circuitry 108 has a mode selection sequence that can be represented as OFF→ON→OFF. When switch 107 is actuated while circuitry 108 is in the OFF mode, circuitry 108 transitions to the ON mode. When switch 107 is actuated while circuitry 108 is in the ON mode, circuitry 108 transitions to the OFF mode. Control circuitry 108 could be implemented in any of various manners, and the choice of a specific circuit is not considered critical. Design of a control circuit to power LEDs (or other type of lighting elements) and provide the above-described operating modes and mode selection sequence would be a routine matter of circuit and component selection for a person of ordinary skill in the art once such a person is provided with the information contained herein. Accordingly, schematics or other details of control circuitry 108 are not included.

Various alternative embodiments include modules having outer dimensions and attachment fittings similar to those of module 100, as well as circuit boards with lighting and other elements similar to those of circuit board 104, but that are configured to have additional operating modes and/or provide different types of illumination. For example, a first alternative embodiment has control circuitry with OFF and FLASH operating modes. In the FLASH mode, that control circuitry continuously flashes module lighting elements on and off at a preset flashing frequency (e.g., ½ second periods of illumination separated by ½ second periods of no illumination). In the first alternative embodiment, the mode selection sequence is OFF→FLASH→OFF. Control circuitry in a second alternative embodiments has ON, CONSTANT and FLASH operating modes and an OFF→CONSTANT→FLASH→OFF mode selection sequence. In particular, actuating a module control switch when the second alternative embodiment circuitry is in the OFF mode places the circuitry in a CONSTANT mode (lighting elements are energized to generate constant illumination), actuating that switch when in the CONSTANT mode places the control circuitry into the FLASH mode (lighting elements continuously flash on and off at a predefined frequency), and actuating the switch in the FLASH mode returns the control circuitry to the OFF mode. In a third alternative embodiment, the control circuitry has OFF and COMBINED operating modes and an OFF→COMBINED→OFF mode selection sequence. In the COMBINED mode, one lighting element outputs constant illumination and another lighting element is continuously flashed on and off.

Numerous other alternative embodiments operate in various other manners. In at least one such alternative embodiment, a module control switch can be repeatedly actuated to change the frequency at which lighting elements are flashed. Actuating the switch while the control circuitry is in an OFF mode will place the circuitry in FLASH1 mode in which the lighting elements are continuously flashed at a first frequency. Actuating the switch while the circuitry is in the FLASH1 mode will place the circuitry into a FLASH2 mode in which the lighting elements are continuously flashed at a different frequency. Any number N of such modes can be included for different flashing frequencies, with a press of the switch when in the last such mode returning the circuitry to an OFF mode (i.e., a mode selection sequence of OFF→FLASH1→FLASH2→ . . . →FLASHN→OFF). Still other embodiments incorporate circuitry that provides different combinations of the illumination methods and operating modes described above. Examples include a module with a CONSTANT mode and multiple FLASH modes (e.g., a mode selection sequence of OFF→CONSTANT→FLASH1→FLASH2→OFF), a module with CONSTANT, FLASH and COMBINED modes (e.g., a mode selection sequence of OFF→CONSTANT→FLASH→COMBINED→OFF), etc.

In still other alternative embodiments, a module combines multiple operating modes with different colors of light. For example, such a module may have a one or more lighting elements that emit visible light and one or more lighting elements that emit infrared light. In an ILLUM1 operating mode, the control circuitry energizes the visible lighting elements. In the ILLUM2 operating mode, the electrical circuitry energizes the infrared lighting elements. The mode selection sequence could be, e.g., OFF→ILLUM1→LLUM2→OFF. In a variation on such an embodiment, additional flashing modes could be included for each set of lighting elements (e.g., ILLUM1_FLASH and ILLUM2_FLASH), and a mode selection sequence could be OFF→ILLUM1→ILLUM1_FLASH→ILLUM2→ILLUM2_FLASH→OFF.

As with the embodiment of FIGS. 1-5, design of a control circuit to power LEDs (or other type of lighting elements) and provide the operating modes and mode selection sequences described for various alternative embodiments would be a routine matter of circuit and component selection for a person of ordinary skill in the art once such a person is provided with the information contained herein. The choice of a specific circuit or collection of circuits to implement one of the above-described alternative embodiments is not considered critical so long as the desired operating modes and selection sequence are provided. Accordingly, schematics or other details of electrical circuitry for the alternative embodiments described above are not included.

As seen in FIGS. 3 and 4, the combination of modules 100 and 300 allows illuminator 10 to be installed onto a bumper at the end of a cable of an operational hoist. Because there is no need to remove the bumper, the hook or other cable hardware from an operational hoist cable as part of installation, illuminator 10 can be easily installed and/or replaced in the field in a short amount of time and without taking a helicopter out of service. The two module configuration of illuminator 10 also offers several other advantages. For example, the presence of two independent modules provides redundancy. If one of modules 100 or 300 is damaged during an operation, the other module can continue to provide illumination.

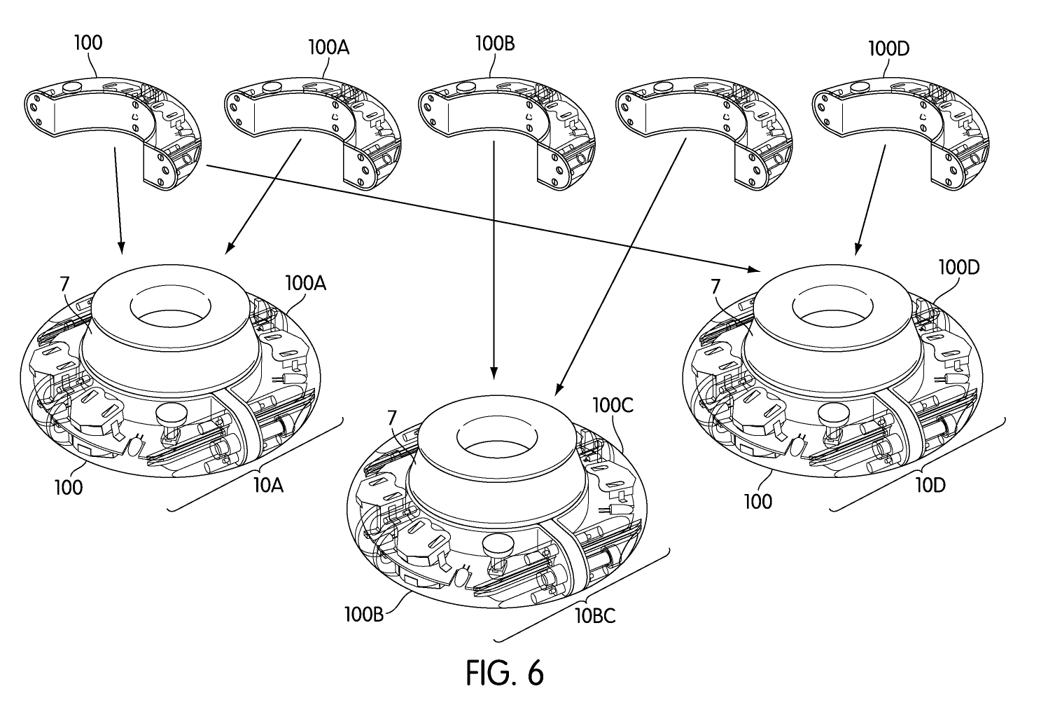

Moreover, the configuration shown in FIG. 4 permits a helicopter crew to combine different types of modules to accommodate different missions and/or other special requirements. For example, FIG. 6 illustrates a set of interchangeable illuminator modules 100, 100A, 100B, 100C and 100D with which a helicopter could be equipped. Each of modules 100 through 100D has similar outer dimensions and attachment fittings, but is configured to provide different types of illumination. Module 100 is described above. For purposes of the example of FIG. 6, it is assumed that module 100 is configured to emit constant visible red light illumination. Module 100A is configured to emit constant visible green light illumination. Module 100B is configured to emit constant infra-red illumination (and substantially no visible light). Module 100C is configured to emit continuously flashing infra-red illumination (and substantially no visible light). Module 100D is configured to emit continuously flashing visible red light illumination.

With this collection of different modules, the helicopter crew can quickly assemble an illuminator on the end of the aircraft's hoist cable that is adapted to a particular need. Modules 100 and 100A can be coupled about bumper 7 to form the two-color illuminator 10A. The helicopter crew can then use the two-color-illuminator to exchange communication between the helicopter and the ground. For example, the helicopter crew can activate only the green module before lowering the cable end to a rescue swimmer in the water. After the cable end has reached the water and the rescue swimmer has attached the hook to a rescued person, the swimmer can deactivate the green module and activate the red module. Upon seeing the red light, the helicopter crew will know that the swimmer is ready for the hoist to be activated.

As another example, a helicopter crew planning a night mission to extract special operations personnel from a combat zone could couple modules 100B and 100C about bumper 7 to form an illuminator (combination 10BC) that is only visible to persons using special night vision equipment. When the helicopter reaches the extraction site, the helicopter crew can activate module 100B before lowering the cable end to the ground. Once the ground personnel have attached the hooked cable end to their harnesses and are ready to be hoisted into the helicopter, they can deactivate module 100B and activate the module 100C. Upon seeing the flashing infra-red illumination from module 100C, the helicopter crew will know to activate the hoist. As yet another example, module 100 can be coupled to module 100B about bumper 7 to create an illuminator that can selectively emit infra-red or visible illumination. As a further example, module 100 and module 100D can be combined about bumper 7 to create illuminator 10D. These examples are not exclusive, and numerous other combinations will be readily apparent in view of the information provided herein.

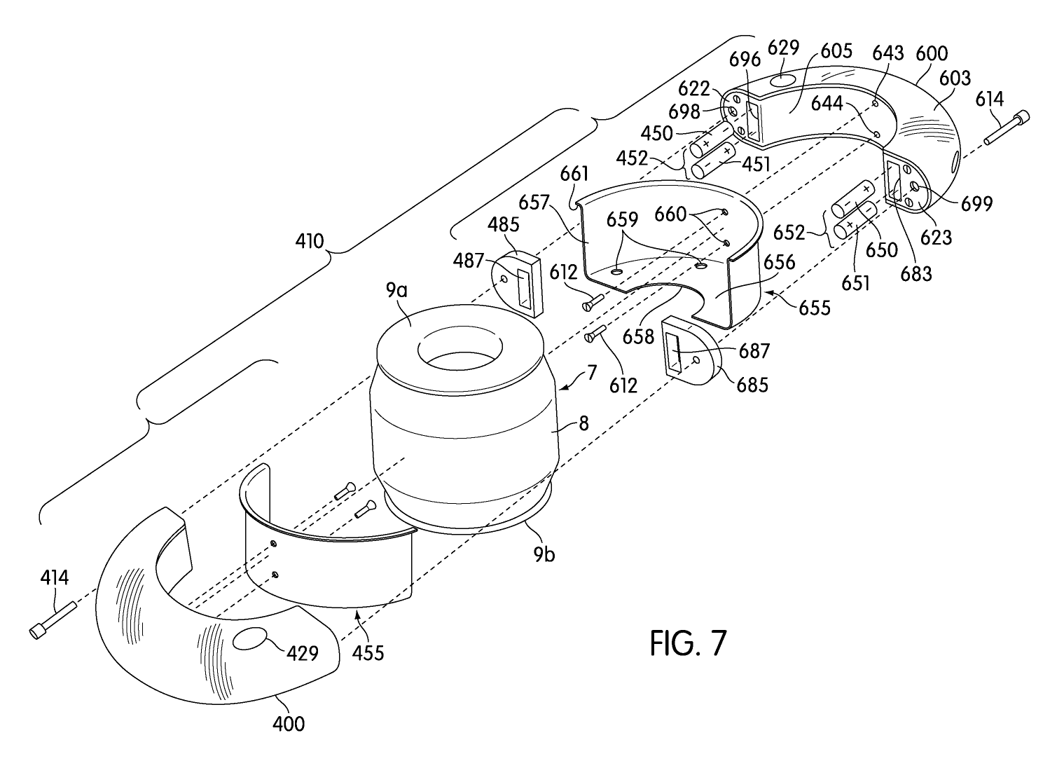

FIGS. 7 through 9 show coupling of illuminator modules to bumper 7 according to some additional embodiments. FIG. 7 is an exploded perspective view of an illuminator 410 and bumper 7 accordingly to some such embodiments. Illuminator 410 includes modules 400 and 600. Modules 400 and 600 are identical, and except as indicated below, are similar to modules 100 and 300 of FIGS. 1-5. For example, module 600 has a clear polycarbonate outer shell 603 and a backing 605 screwed to outer shell 603. Although internal components of modules 400 and 600 are omitted from FIG. 7 for simplicity, each includes a circuit board mounted inside the outer shell. Each of those circuit boards has multiple LEDs (arranged similar to the LEDs 109 shown in FIG. 4) and electrical control circuitry configured to control operation of those LEDs in response to user input. Similar to modules 100 and 300 described above, user input to modules 400 and 600 is received via diaphragms 429 and 649, with force applied to said diaphragms being transferred to an internal switch via a push block.

Unlike modules 100 and 300 described above, modules 400 and 600 are powered by “AA” size batteries. Module 600 is powered by AA batteries 650 and 651, which form a battery pack 652. Batteries 650 and 651 are oriented with the negative terminal of battery 650 adjacent the positive terminal of battery 651. Battery pack 652 further includes a bracket (not shown) holding batteries 650 and 651 parallel to one another and electrically connecting the negative terminal of battery 650 to the positive terminal of battery 651. Module 400 is powered by batteries 450 and 451, which are similarly held together and electrically connected by a bracket (not shown) to form battery pack 452.

Battery packs 652 and 452 are inserted into battery compartments formed by mating ends of modules 400 and 600. In particular, one end of battery pack 652 goes into battery chamber 683 in end face 623 of module 600. One end of battery pack 452 goes into battery chamber 696 in face 622 of module 600. The other end of battery pack 652 goes into a battery chamber 496 in module 400 (see FIG. 9) that is identical to battery chamber 696 of module 600, and the other end of battery pack 452 goes into a battery chamber 483 in module 400 (FIG. 9) that is identical to battery chamber 683 of module 600. Cutouts 687 and 487 in gaskets 685 and 485, respectively, allow battery packs 652 and 452 to pass through. Gaskets 685 and 485 seal battery chambers 683, 696, 496 and 483 when illuminator 410 is assembled.

Battery chamber 683 is closed on all sides except for the opening shown in face 623. The rear wall of chamber 683 includes conductive elements that pass through (and are sealed to) that rear wall, which conductive elements contact the positive terminal of battery 650 and the negative terminal of battery 651 and carry current from battery pack 652 to the electrical circuitry of module 600. Battery chamber 483 in module 400 is similarly constructed so as to carry current from battery pack 452 to the electrical circuitry of module 400.

Modules 400 and 600 are coupled to bumper 7 in a different manner than that used to couple modules 100 and 300 to bumper 7. Specifically, modules 400 and 600 are coupled to bumper 7 using a pair of mounting sleeves 455 and 655. Sleeves 455 and 655 are identical, and thus only sleeve 655 need be described in detail. Sleeve 655 has a flange 656 and a cylindrical wall 657. A cutout 658 and a plurality of drain holes 659 are formed in flange 656. A plurality of attachment holes 660 and a lip 661 are formed in wall 657. In the embodiment of FIGS. 7-9, sleeves 455 and 655 are substantially semicircular. In other embodiments, however, either or both of sleeves 655 and 455 may correspond to circular arcs that cover significantly less than 180 degrees, and/or that correspond to circular arcs that are significantly different from the arcs to which coupled illumination modules correspond. For example, in some embodiments each of modules 400 and 600 could be coupled to a mounting sleeve that that corresponds to a circular arc of 90 degrees. In at least some embodiments, sleeves 455 and 655 are formed from 0.036 sheet 304 stainless steel.

Sleeve 655 attaches to module 600 by inserting screws 612 through holes 660 and screwing those screws into threaded holes 643 and 644. Sleeve 455 is attached to module 400 in a similar manner. Illuminator 410 is then assembled onto bumper 7 by inserting flange 656 between strike plate 9b and rubber main body 8 of bumper 7. One end of battery pack 652 is placed into battery chamber 683 and gasket 685 placed over battery pack 652 so as to be adjacent to face 623 of module 600. One end of battery pack 452 is placed into battery chamber 696 and gasket 485 placed over battery pack 452 so as to be adjacent to face 622 of module 600. Module 400 is put into place by inserting flange 456 into the space between strike plate 9b and rubber main body 8 on an opposite side of bumper 7 from sleeve 655/module 600, with the other ends of battery packs 652 and 452 being simultaneously inserted into the battery chambers 496 and 483 of module 400. Screw 614 passes through a hole 699 in module 600 and into a threaded hole in module 400 and is tightened. Screw 414 passes through a hole in the other end of module 400 and into threaded hole 698 in module 600 and is tightened.

In some embodiments similar to that of FIGS. 7-9, and because battery packs 452 and 652 are not mounted on a circuit board inside a module, a module backing can be glued to an outer shell of the module.

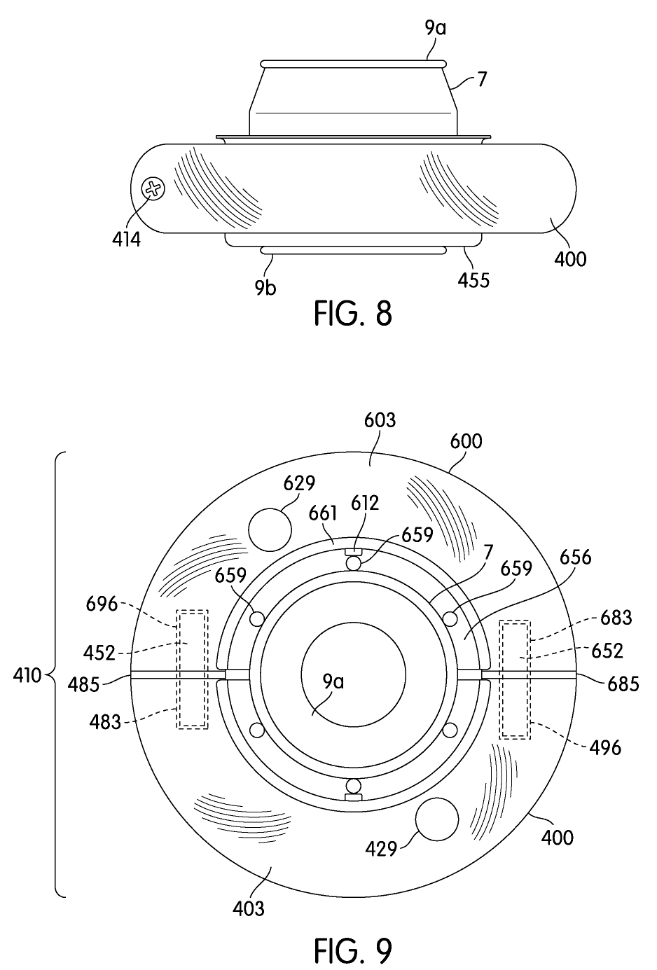

FIG. 8 is a side view of illuminator 410 and bumper 7 taken from the outside edge of module 400. FIG. 9 is a top view of illuminator 410 and bumper 7.

Modules 400 and 600 both contain red LEDs (or other type of lighting elements) and that have a constant illumination state when activated. In other embodiments, modules coupling to a bumper in the same manner as modules 400 and 600 can have features similar to any of the previously-described embodiments that are coupled to a bumper without use of mounting sleeves. For example, modules similar to modules 400 and 600 may have other color lighting elements (visible and/or infra-red) and/or colored outer shells, flashing operating modes, different mode selection sequences, etc. Similarly, and as was described in connection with FIG. 6, a helicopter could be equipped with a set of interchangeable modules of different colors and/or operating modes and that couple to a bumper as shown in FIGS. 7-9, and that can be combined to suit a particular mission requirement. As with the embodiments of FIGS. 1-6, illuminators similar to the illuminator 410 of FIGS. 7-9 can be mounted to a bumper without removing the bumper or hook from a cable, and without removing a helicopter from service.

In some embodiments where a module is configured to provide constant or no illumination (i.e., the module does not include a flashing mode), the module can be have electrical circuitry that simply places two batteries (e.g., batteries 650 and 651) in parallel and three LEDs in parallel when a switch is closed so all three LEDs are energized by the two batteries. As indicated above, however, design of a control circuit to power LEDs (or other type of lighting elements) and provide any of the above-described operating modes and mode selection sequences would be a routine matter of circuit and component selection for a person of ordinary skill in the art once such a person is provided with the information contained herein.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. Any and all permutations of features from above-described embodiments are the within the scope of the invention.

1. An apparatus comprising:
a first housing having first and second ends and a concave inner region between the first and second ends, wherein the first housing is configured for coupling to a second housing having a like concave region, a like first end and a like second end;
a first lighting element contained with the first housing and energizable to cause illumination to emanate from the first housing; and
control circuitry contained within the first housing and configured to energize the first lighting element in response to a user input.

2. The apparatus of claim 1, wherein the concave inner region is arcuate.

3. The apparatus of claim 2, wherein the concave inner region includes a protrusion extending radially inward.

4. The apparatus of claim 2, wherein the first lighting element emits infra-red illumination and substantially no visible light when energized.

5. The apparatus of claim 2, wherein the control circuitry is configured to continuously flash the first lighting element at a predetermined frequency in response to a first user input and to discontinue the continuous flashing in response to a second user input.

6. The apparatus of claim 2, further comprising
a second housing having first and second ends and an arcuate concave inner region between said first and second ends, wherein the second housing is configured for coupling to the first housing by coupling the first end of the second housing to the second end of the first housing and by coupling the second end of the second housing to the first end of the first housing;
a second lighting element contained with the second housing and energizable to cause illumination to emanate from the second housing; and
control circuitry contained within the second housing and configured to energize the second lighting element in response to a user input, and wherein
the control circuitry contained in the first housing is configured to continuously flash the first lighting element at a predetermined frequency in response to a first user input and to discontinue the continuous flashing in response to a second user input, and
the control circuitry contained in the second housing is configured to energize the second lighting element to generate constant illumination.

7. The apparatus of claim 2, further comprising
a second housing having first and second ends and an arcuate concave inner region between said first and second ends, wherein the second housing is configured for coupling to the first housing by coupling the first end of the second housing to the second end of the first housing and by coupling the second end of the second housing to the first end of the first housing;
a second lighting element contained with the second housing and energizable to cause illumination to emanate from the second housing; and
control circuitry contained within the second housing and configured to energize the second lighting element in response to a user input, and wherein
the illumination emanating from the first housing when the first lighting element is energized is a first color, and
the illumination emanating from the second housing when the second lighting element is energized is a second color different from the first color.

8. The apparatus of claim 7, wherein the first color is infra-red and substantially no visible light emanates from the first housing when the first lighting element is energized, and wherein the second color is in the visible light portion of the spectrum.

9. The apparatus of claim 1, further comprising a mounting sleeve coupled to the first housing and having a flange extending into at least a portion of the concave inner region.

10. An apparatus, comprising:
a hoist cable bumper;
a first illumination module configured to emit illumination when activated, the first illumination module including first and second ends and a substantially semicircular concave region located between the first and second ends, the concave region surrounding a side portion of the bumper; and
a second illumination module configured to emit illumination when activated, the second illumination module including first and second ends and a substantially semicircular concave region located between the first and second ends, said concave region surrounding another side portion of the bumper, wherein
the first end of the first illumination module is coupled to the second end of the second illumination module, and
the second end of the first illumination module is coupled to the first end of the second illumination module.

11. The apparatus of claim 10, wherein the first and second illumination modules are identical.

12. The apparatus of claim 10, wherein the first illumination module is configured to emit a first color illumination when activated and the second illumination module is configured to emit a second color illumination when activated, and wherein the first color is different from the second color.

13. The apparatus of claim 10, wherein the first illumination module is configured to emit infra-red illumination when activated and to emit substantially not visible light when activated.

14. The apparatus of claim 10, wherein the first illumination module is configured to emit a flashing illumination pattern when activated.

15. The apparatus of claim 10, wherein the concave region of the first illumination module and the concave region of the second illumination module each includes a protrusion extending radially inward into the bumper.

16. The apparatus of claim 10, wherein
the first illumination module is coupled to a first mounting sleeve having a flange extending into at least a portion of the substantially semicircular concave region located between the first and second ends of the first illumination module,
the second illumination module is coupled to a second mounting sleeve having a flange extending into at least a portion of the substantially semicircular concave region located between the first and second ends of the second illumination module, and
at least a part of each of the flanges is situated between a main body portion of the bumper and a strike plate of the bumper.

17. An illuminator kit, comprising:
a first illumination module configured to emit a non-flashing first color illumination when activated, the first illumination module including first and second ends and a substantially semicircular concave region located between the first and second ends;
a second illumination module configured to emit a second color illumination when activated, the second illumination module including first and second ends and a substantially semicircular concave region located between the first and second ends, wherein the second color is different from the first color; and
a third illumination module configured to emit a flashing illumination pattern when activated, the third illumination module including first and second ends and a substantially semicircular concave region located between the first and second ends, wherein
any two of the first, second and third illumination modules can be coupled around a cylindrical surface by coupling the first end of each module in the pair to the second end of the other module in the pair so as to form a ring structure surrounding the cylindrical surface.

18. The illuminator kit of claim 17, wherein any two of the first, second and third illumination modules can be coupled around a cylindrical surface by coupling the first end of each module in the pair to the second end of the other module in the pair so as to form a ring structure compressing the cylindrical surface.

19. The illuminator kit of claim 17, wherein
the first illumination module is coupled to a mounting sleeve having a flange extending into at least a portion of the substantially semicircular concave region located between the first and second ends of the first illumination module, and
the second illumination module is coupled to a mounting sleeve having a flange extending into at least a portion of the substantially semicircular concave region located between the first and second ends of the second illumination module.

20. The illuminator kit of claim 17, wherein at least one of the illumination modules is configured to emit infra-red illumination and to emit substantially no visible light when activated.

21. The illuminator kit of claim 17, wherein the concave region of each of the illumination modules includes a protrusion extending radially inward.
